(19) United States
(12) Patent Application Publication
(10) Pub. No.: US 2009/0204697 A1
(43) Pub. Date: Aug. 13, 2009

(54) Methods and apparatus for extended error reporting in network management

(75) Inventors: Malyadri Jaladanki, San Jose, CA (US); Yi Wang, Cupertino, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs San Jose, Inc., Naperville, IL (US)

(21) Appl. No.: 12/378,512

(22) Filed: Feb. 17, 2009

Related U.S. Application Data
(63) Continuation of application No. 11/335,098, filed on Jan. 18, 2006, now abandoned.
Application No. 11/335,098 is a continuation-in-part of application No. 10/347,972, filed on Jan. 21, 2003, now Pat. No. 7,032,891.
(60) Provisional application No. 60/645,218, filed on Jan. 18, 2005.

(51) Int. Cl. G06F 15/16

(52) U.S. Cl. 709/223

(57) ABSTRACT

Standard SNMP error reporting between a network element and a management system utilizes a set of standard error codes that provide limited information about a fault condition. Example embodiments of the invention provide reporting of an extended error code that provides information for locating the source of a fault condition and for debugging the fault condition. In response to a first request, the extended error code can be reported to a management system. In response to a request following the extended error code, meanings associated with the extended error code are reported to a management system, thereby informing a network administrator of the fault condition.

### BACKGROUND OF THE INVENTION

A typical Network Manager (e.g., Network Management System (NMS) or other device) monitors and controls one or more network elements, such as service routers, terminal servers, and other networked devices, via communications across a network. The Network Manager can collect data indicating operational conditions of the network elements, configure or reconfigure the network elements, or can actively control a network element through a series of commands or requests.

Simple Network Management Protocol (SNMP) is a common protocol used in network management. In a typical SNMP configuration, a Manager, configured as an SNMP Manager, communicates with one or more SNMP agents, which include software components operating at each managed network element. The SNMP agent maintains operational data, status information and configuration data for its respective network element, interfaces with the Manager to provide such data in response to a request by the Manager (e.g., a “GET” request), or provides data without request (e.g., in response to an alarm condition or a fault, TRAP).

A Management Information Base (MIB), as implemented in an SNMP system, stores information regarding the data exchanged in SNMP communications. A common MIB database is structured hierarchically and includes information on particular SNMP requests, variables associated with said request, and the managed devices of the network elements. A common entry within the MIB, known as a managed object, can be defined by syntax (data structure of object type), access (read-write or read-only), and description.

### SUMMARY OF THE INVENTION

Example embodiments of the present invention provide a method of extended error reporting from a network element to a Network Manager using fields in SNMP Response Message. In the event of a fault condition, in response to a first request from a Network Manager (e.g., a Network Management System (NMS)), an error code is provided in a response message. The error code includes debug information beyond a standard error code. In response to a second request from the Manager, where the second request includes an indication of the debug information, a response is provided that includes meanings of the debug information.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a network system including a Manager Application and an associated Managed Network Element according to an embodiment of the invention.

FIG. 2A is a flow diagram of a procedure of providing extended error reporting.

FIG. 2B is a Sequence diagram illustrating communications between Manager and Network Element in an extended error reporting procedure.

FIG. 2C is a Sequence diagram illustrating messages exchanged between Manager and network element in an extended error reporting procedure

FIG. 2D is a block diagram illustrating communication between Manager and network element in an extended error reporting procedure

FIG. 2E is a table of error codes supported in standard SNMP communications.

FIG. 3 is a diagram of a GET_RESPONSE Protocol Data Unit (PDU) with extended error code implementation usable in example embodiments of the present invention.

FIG. 4A is a user interface screenshot of a GET RESPONSE PDU raw data output usable in example embodiments of the invention.

FIG. 4B is a byte layout diagram illustrating decoding of extended error code with associated meanings for each byte segment.

FIG. 5A is a block diagram of a network configuration featuring a single Network Manager managing multiple Network Elements (NE).

FIG. 5B is a block diagram of a network configuration featuring multiple Network Managers managing a single NE.

FIG. 6A is a diagram showing structure of Manager Error Reporting MIB usable in example embodiments of the invention.

FIG. 6B is a diagram showing structure of Extended Enterprise Error Information MIB usable in example embodiments of the invention.

### DETAILED DESCRIPTION OF THE INVENTION

A description of example embodiments of the invention follows.

During a typical Simple Network Management Protocol (SNMP) management process, a Network Manager application (e.g., a Network Management System (NMS) or other device) transmits, across a network, a request to an SNMP agent residing at a network element (NE) to modify data or retrieve data about the status of the network element. For example, a GET request from the Manager directs the SNMP agent to retrieve particular data about the respective network element and transmit that data to the manager. The data can include identity and status information about the network element or one or more modules that are electrically or logically connected within the network element.

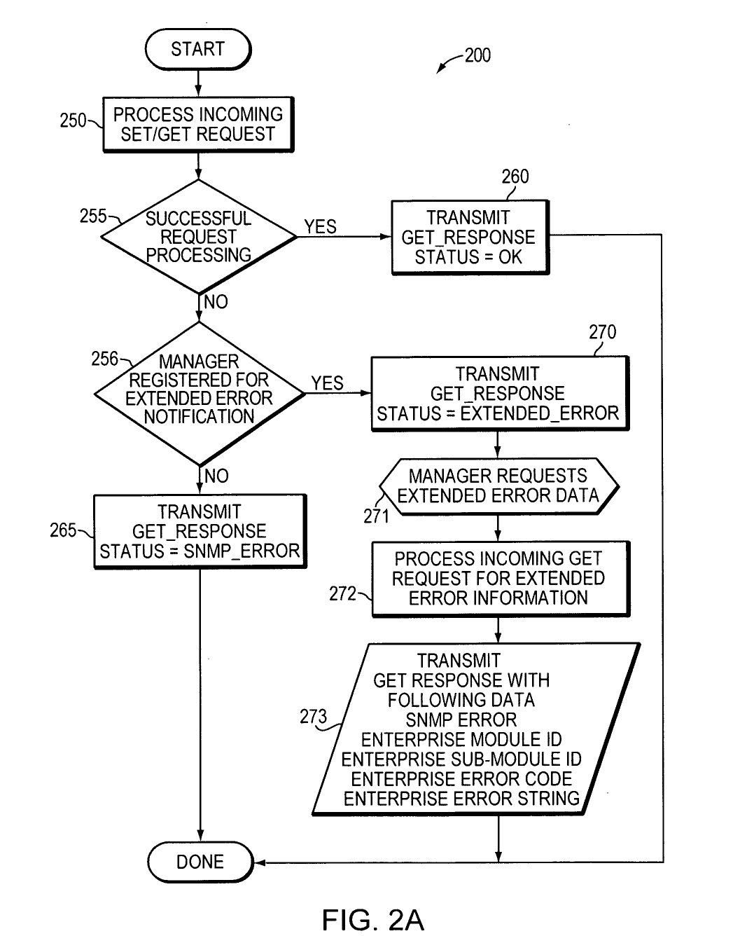

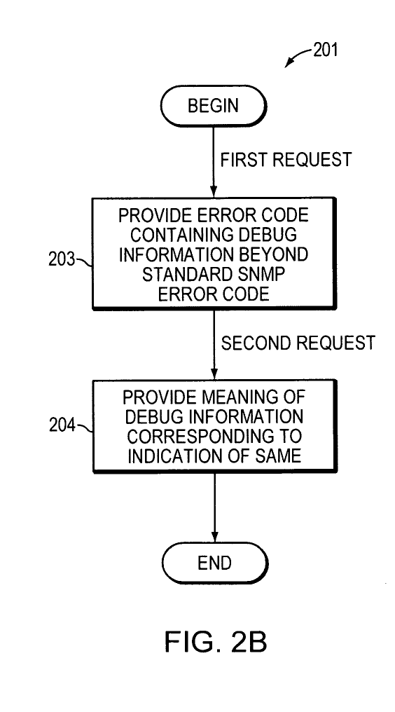

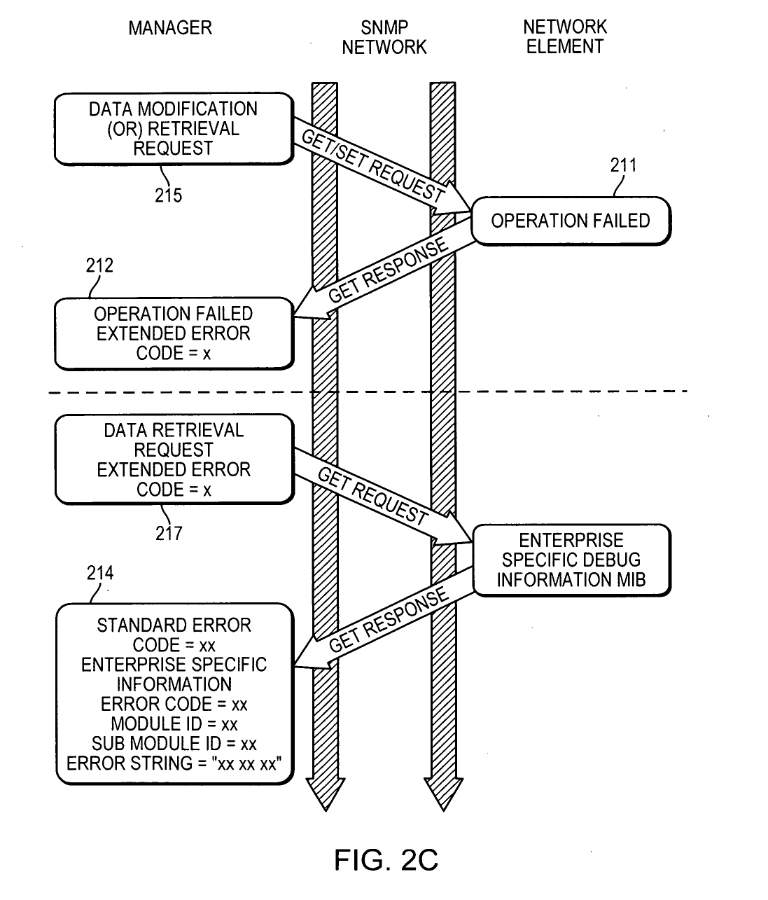

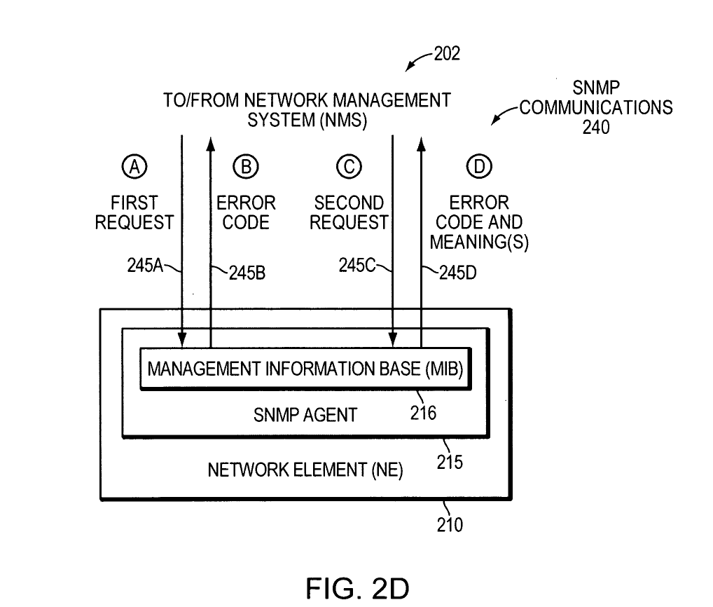

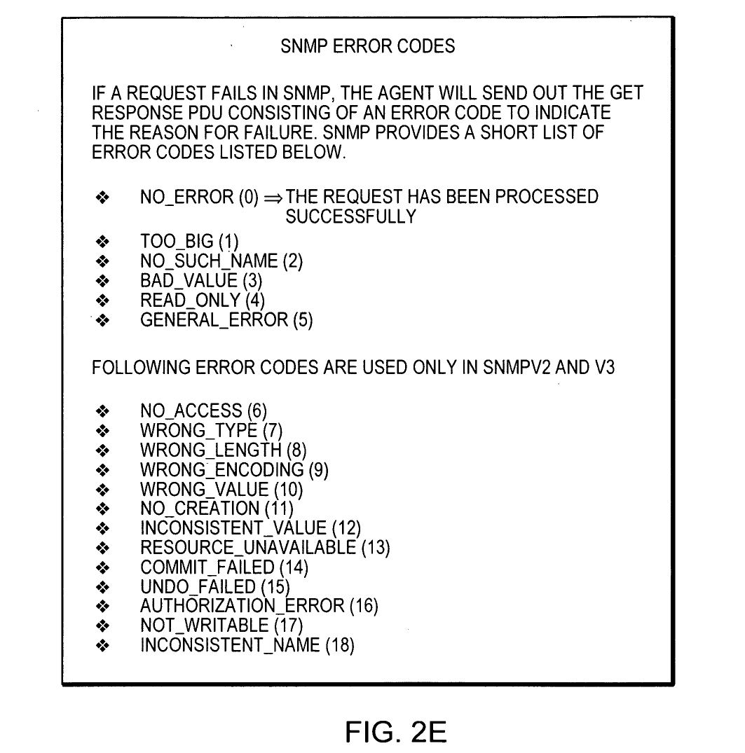

In an event of a fault condition at the network element, the SNMP agent may respond to a GET request, a SET request or other inquiry with a GET_RESPONSE message containing an error code. A standard SNMP error code indicates one of a number of fault conditions at the network element, and may contain one of the code values shown, for example, in FIG. 2C. A particular error code, when reported to a network administrator, provides some basic information about the fault condition.

Standard SNMP error reporting suffers from a number of drawbacks. The standard SNMP error code provides only limited information about a fault condition, including the general location of the fault (i.e., a particular network element), and a broad (generic) category that characterizes the error. For example, a received SNMP error code “WRONG_VALUE” may correspond to a MIB entry with the definition: “The value cannot be assigned to the variable.” Yet in order to address this fault, a network administrator must complete further diagnostic actions to locate more precisely the source of the error. Moreover, the standard SNMP error code fails to aid a network administrator in debugging software responsible for the fault condition, as the error code only provides minimal information about the fault condition. Thus, upon receiving a standard error code, a network administrator may be required to run-further diagnostics to locate the source and the nature of the fault condition before it can be corrected, consuming additional time and network processes.

Example embodiments of the present invention provide for extending error reporting from a network element to a Network Manager (e.g., a Network Management System (NMS) using SNMP or other management protocol). In the event of a fault condition, in response to a first request from a Network Manager, an agent at the network element provides a response message including an extended error code. The extended error code corresponds to debug information beyond a standard error code, such as a standard SNMP error code. The agent then receives a second request from the Manager, where the second request includes an indication of the debug information. In response, the agent provides the Manager with meanings of the debug information. As a result, the agent provides the Manager with detailed information regarding a detected fault condition, which can be used for efficient diagnostics and debugging of the network element.

In further embodiments of the invention, the indication of the debug information provided by the Network Element may be the debug information itself. The debug information may also be enterprise specific debug information (ESDI). If ESDI functionality is available, a network element may advertise to the Manager its availability by sending out a TRAP message.

In still further embodiments of the invention, error reporting may be selectively enabled for standard error reporting (e.g., standard SNMP error codes) or extended error reporting using a Management Information Base (MIB). Such enabling may be applied to a single manager or to multiple managers on a per-manager basis. In the event of a fault condition, in responding to the first request, a response message may include more significant bits in an error code field carrying the extended error code than is used in the standard error code. The meanings of the debug information can include: an indication of a module, indication of a sub-modules, hierarchy among modules or sub-modules within the network element, human readable error string associated with a detected fault condition, combinations thereof, or other relevant information.

In still further embodiments of the invention, a Management Information Base (MIB) that includes the meanings can be enabled, to be updated in a manner independent of the manager. In embodiments where the standard error code is an SNMP error code, space may be reserved beyond the standard set of SNMP error codes in the error status field within the response message.

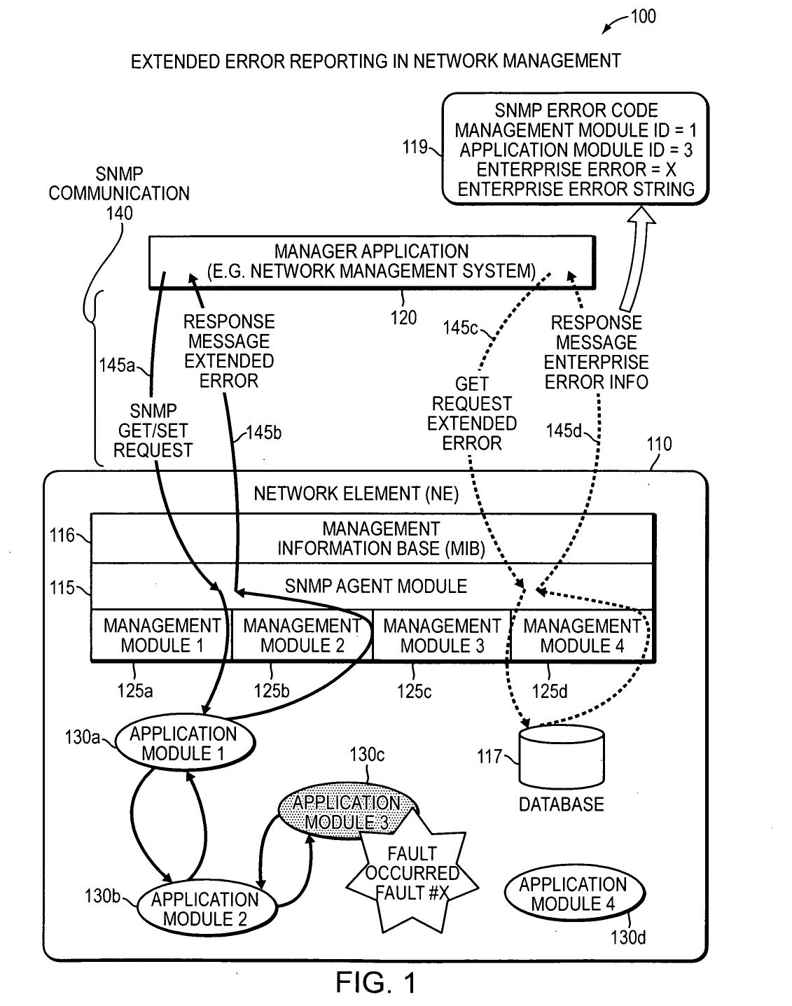

FIG. 1 is a block diagram of a network system 100 including a Network Manager 120 and an associated network element 110. The Manager 120 may be a network terminal configured for administrative access to one or more managed network elements (e.g., service routers, terminal servers) across a network (not shown). The network element 110 may be a multi-service router that includes a number of component modules, including application modules 130a-d and management modules 125a-c. The application modules 130a-d may include a range of different network devices configured to interface with the network. The management modules 125a-c manages the application modules 130a-d within the network element 110, e.g., port configuration, bandwidth allocation and access control. Example application modules 130a-d includes port modules, alarm modules, wireless modules, or other modules that may be employed by a network element.

A network element agent 115, employing a Management Information Base (MIB) 116, provides an interface at the network element 110 to communicate with the Manager 120. The agent 115 may be configured as an SNMP agent or an agent associated with another communications protocol, and may be implemented in hardware, software, or combination thereof. As an SNMP agent, the agent 115 is responsive to SNMP requests (e.g., “SET”) issued by the Manager 120 to modify configuration data of the modules 125a-c, 130a-d and returning the data to the Manager 120 as defined by the requests. The agent 115 may also transmit data to provide notifications without such requests, such as in response to an alarm or fault condition at one of the modules 125a-c, 130a-d, using TRAP messages. In addition to informing the Manager 120 of operational conditions or changes at the network element, the agent 115 may be responsive to Manager 120 requests to configure or reconfigure settings at one or more of the modules 120A-C, 130A-D using the Management Information Base 116 (described below).

The Management Information Base (MIB) 116 may be configured as a hierarchical database to maintain information on the data exchanged in the communications (e.g., SNMP communications 140) between the Manager 120 and the agent 115. The MIB 116 may include information on particular SNMP requests, variables associated with the requests, and the managed devices of the network elements. An entry in the MIB, known as a managed object, can be defined by syntax (data structure of object type), access (read-write or read-only), a description (e.g., a human-readable string), and other properties.

The Manager 120 communicates with the network element 110 across the network to monitor, manage, and reconfigure the network element 110. In this example embodiment, such communications may follow Simple Network Management Protocol (SNMP), with the exception that the communications are modified, as described below, to accommodate extended error reporting.

In an example procedure of extended error reporting via SNMP communications 140, The Manager 120 issues an SNMP request 145a to the agent 115. If the agent 115 cannot complete the request, or is otherwise required to report a fault condition, then the agent reports an extended error code 145b in the response message (error code “N”) corresponding to the fault to the Manager 120. The agent 115 may determine the appropriate error code by comparing characteristics of the fault condition (including the associated module and sub-module) against the descriptions of error codes and module/sub-module identifiers stored at the database 117 associated with the MIB 116.

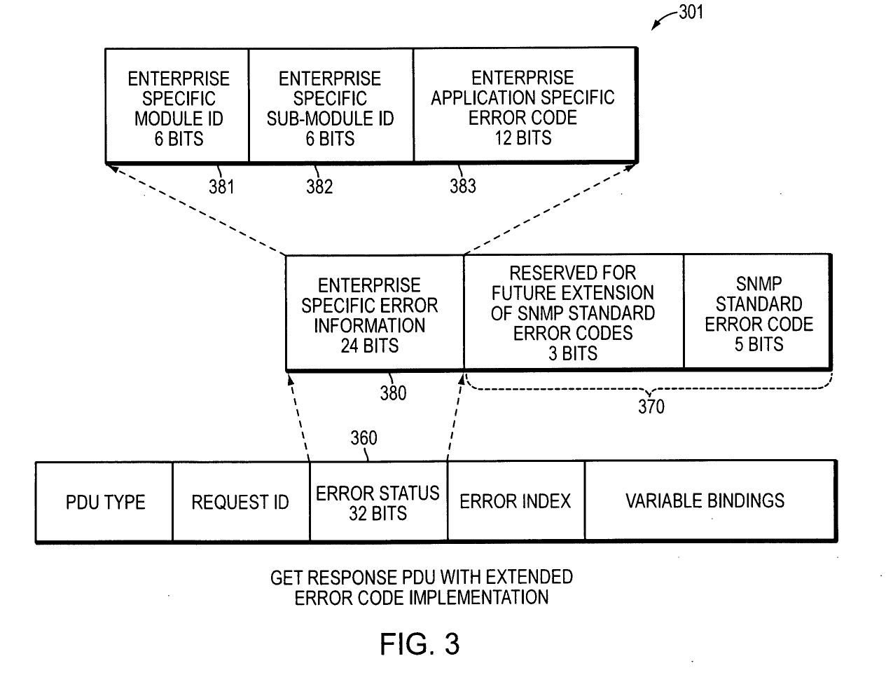

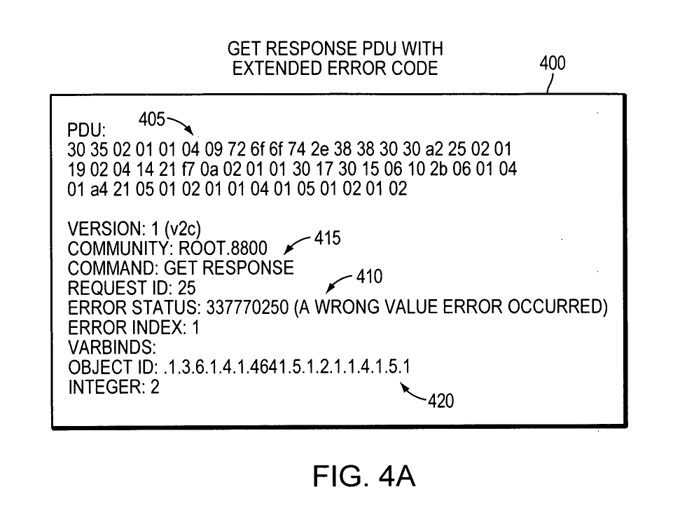

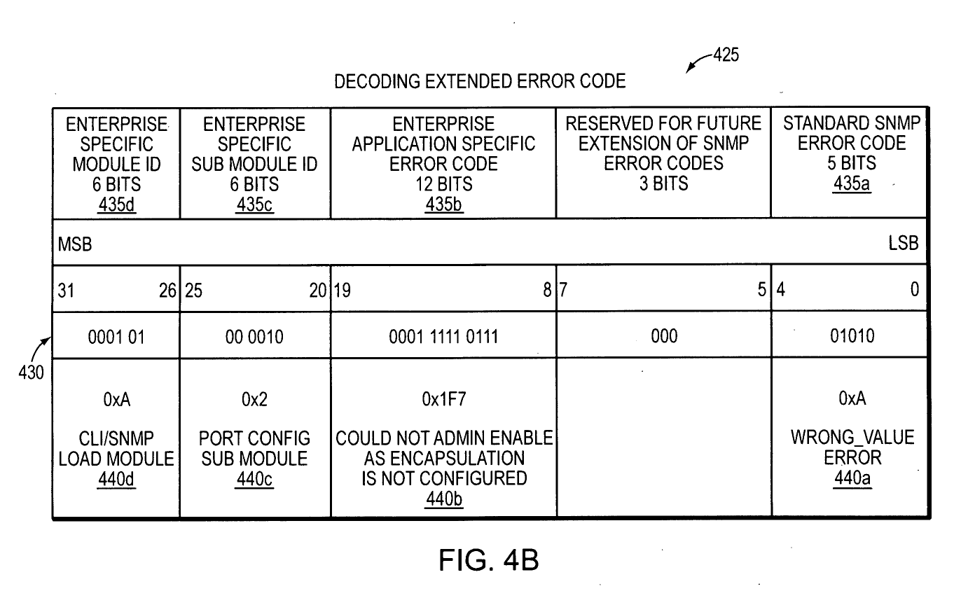

In contrast to a standard (e.g., SNMP) error code, the extended error code provides additional information regarding the respective fault condition. The structure and content of an extended error code in response message 145b and a standard error code are described in further detail below, with reference to FIGS. 3, 4A and 4B. Although the Manager 120 may be configured for receiving and reporting standard error codes, it may not be configured for processing the extended error code in response message 145b. As a result, the Manager may interpret an extended error code in response message 145b as a communications error or may not be able to convey the meaning of the extended error code in response message 145b to a network administrator or other operator. Thus, in this example embodiment, the Manager 120 issues a GET request 145c to receive further information regarding the extended error code received in response 145b. The GET request 145c includes the extended error code, which may include the extended error code itself. The GET request 145c is received by the agent 115, which, in turn, accesses the database 117 to retrieve information regarding (i.e., the meaning of) the extended error code in response message 145b. The agent 115, therefore, interprets the error code received in message 145b through the MIB 116 to determine the meaning of the error code, and forwards the error code meanings 145d in responsive SNMP communications 140 to the Manager 120.

The error code meanings 119 can include all information indicated by the extended error code in response message 145b, such as a standard (e.g., SNMP) error code, module identifier (ID), sub-module ID (hardware or software component of the identified module), extended error code (e.g., enterprise-specific debug information (ESDI)), or extended error string (a human-readable description of the ESDI or other extended error code). The meanings 145D may further be reported to a network administrator as detailed diagnostic information to assist in a process of debugging the network element 110 to correct the respective fault condition.

Through the use of the foregoing procedure, the Manager 120 need not be configured with information about the extended error codes; nor does the Manager 120 need to commit processes to determine the meaning of received extended error codes. Rather, such information is maintained and processed at the agent 115 of the network element 110 using a database 117. Embodiments of the invention can therefore enable compatibility among multiple different Managers and network elements, which may not be configured to report and process extended error codes, or may not do so in identical format. For example, a Manager 120 may manage multiple network elements (not shown), each of which includes a different set of modules, and so is configured to report from a different selection of extended error codes to correspond to each network elements' application-specific (e.g., ESDI) fault conditions. Similarly, the extended error codes can be customized within a MIB 116 of a network element independent of configurations at other network elements, thereby optimizing error codes and debug information on a per-network element basis. Example embodiments of the invention therefore allow extended error reporting that can be optimized for each network element, while also enabling multiple different configurations of extended error reporting across network elements, where a Manager does not require a unique entry for each such configuration.

FIG. 2A is a flow diagram of a process 200 of extended error reporting. The Process 200 may be implemented in the network element 110 described above with reference to FIG. 1, and may incorporate features described above. In response to a first SET/GET request from a Manager (e.g. NMS) (250), an error code is provided in a response message, the error code including debug information (e.g., enterprise error code) beyond a standard error code (only is the Manager has registered to receive extended error codes) if the NE fails to process this request. In response to a follow-up request from the Manager, where this request is for retrieval of information associated with the enterprise error code returned in previous request, a response is provided that includes meanings of the enterprise error information, comprising of the exact nature of fault, location of fault (module, sub-module) etc.

FIG. 2B is a sequence diagram of a process 201 illustrating communications between Manager and Network Element in an extended error reporting procedure. The Process 201 may be implemented in the network element 110 described above with reference to FIG. 1, and may incorporate features described above. Upon receiving a first request (e.g., an SNMP “SET” command), an error code is transmitted including debug information beyond a standard (e.g., standard SNMP) error code (203) if the NE fails to process this request. In response to a second request (e.g., a request for further information on the error code, which may include an indication of the error code or the error code itself), a response message is transmitted (204). The response message includes meanings of the debug information, such as module/sub-module identifiers and human readable error string(s) corresponding to the extended error code and associated standard error code.

FIG. 2C is a Sequence diagram illustrating messages exchanged between Manager and network element in an extended error reporting procedure. The communications follow the process 200 described above with reference to FIG. 2A. A network element (e.g., NE 110 in FIG. 1) receives a first request 215 (e.g., an SNMP “SET” or “GET” request). On failure to process this request (211), the network element transmits an error code in the response message 212, which includes extended error codes beyond a standard (e.g., standard SNMP) error code. In response to a second GET request 217 from manager to retrieve information related to the error code received in previous response message, the network element transmits a message 214 including the meaning of the error codes.

FIG. 2D is a block diagram of a system 202 including a network element 210 configured for providing extended error reporting. The network element 210 includes an agent 215 (e.g., an SNMP agent) and a management information base (MIB) 216, and may be configured further in a manner similar to the network element 110 described above, and SNMP communications 240 and associated processes may be comparable to those described above with reference to FIGS. 1 and 2A-B. In particular, the agent 215 may respond to a first request 245a, from, for example, a management system, by providing an extended error code 245b having an indication of debug information beyond a standard error code when the agent 215 fails to process the incoming request or detects a fault condition. In response to a second request 245c, which may include an indication of the error code or the error code itself, the agent 215 retrieves meanings of extended error code 245b and transmits those meanings 245d to the management system.

FIG. 2E is a diagram showing the SNMP standard set of 18 error codes that may be returned by the network element in case of failure to process an incoming request from Manager. Any such error codes are embedded in the ERROR_STATUS field of a GET_RESPONSE Message. Since 18 such error codes are defined by SNMP standard, they can be comfortable embedded in lower 5 bits of the 32-bit ERROR_STATUS field in the GET_RESPONSE message.

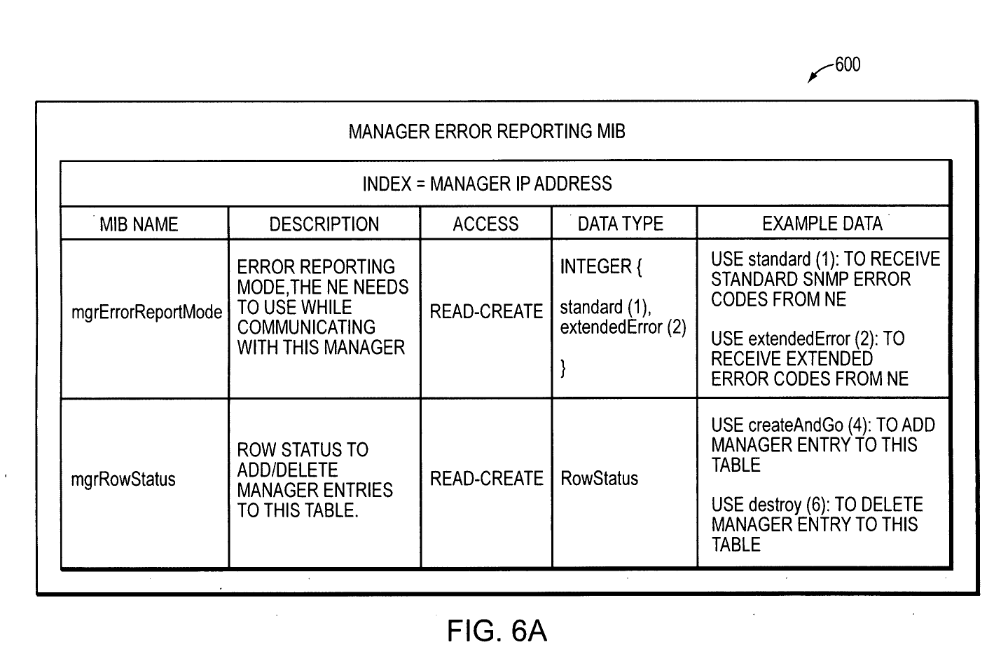

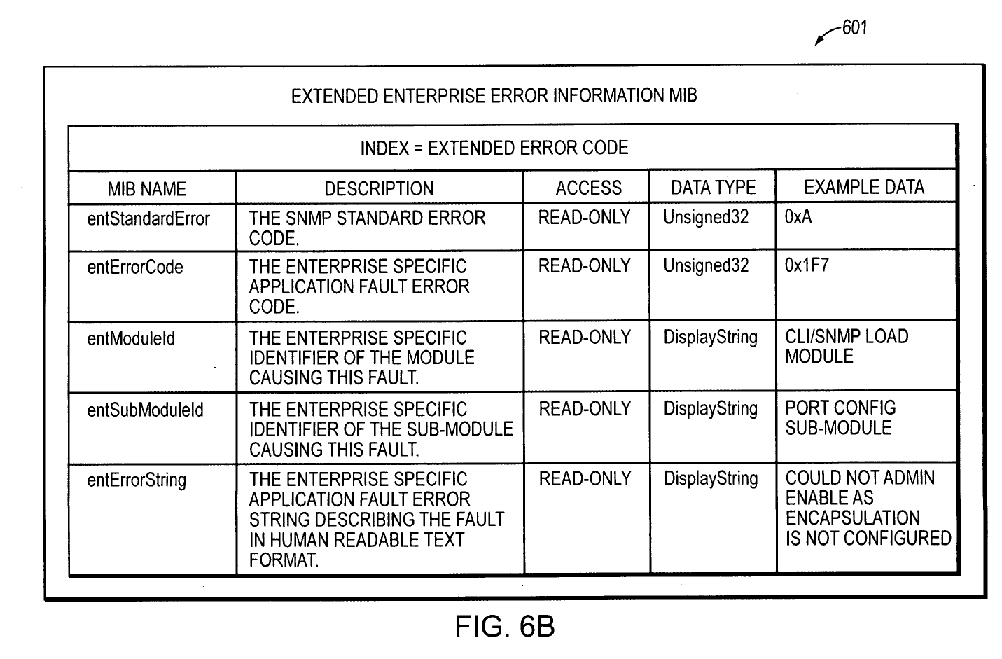

FIG. 3 is a diagram of a GET_RESPONSE Protocol Data Unit (PDU) 301 with extended error code implementation associated with example embodiments of the present invention. The ERROR_STATUS field 360, being 32-bits in length, includes a standard error code 370, such as a standard SNMP error code, having an 8-bit segment (the upper 3 bits being reserved for future extendibility of SNMP error codes). The remaining 24 bits, which include extended debug (e.g., enterprise specific) information 380, are divided into segments storing three further indicators. A module ID (6 bits) 381 includes a code identifying the module responsible for a fault condition. A sub-module ID (6 bits) 383 identifies the sub-module, being a component of the module that is responsible for the fault condition. An extended error code (12 bits) 383 identifies debug information relating to the fault. The Manager may be configured so as not to interpret the meanings, the byte-layout, or the specific contents of the extended error field. The Manager may rely on the Network Element (Using, e.g., the MIB shown in FIG. 6B) to decode and interpret the contents of the Extended error code field thus allowing the flexibility of changing the structure of the extended error field (24-bits) in future. It should be understood that the extended error code may be subdivided more or fewer times or have segments of predefined or adjustable length, depending upon implementation in the network element. Example extended error codes and related processes are described in further detail below with reference to FIGS. 4A and 4B.

FIG. 4A is a user interface screenshot 400 of a GET_RESPONSE Protocol Data Unit (PDU) 405. Such a PDU may be conveyed, for example, by a network element to a network manager (e.g., an NMS) in response to a request from Manager. Included in the screenshot is an extended error code 410 itself, an indication of the request 415 that contains the extended error code, information on the extended error code, and ancillary data 420. The screenshot 400 may correspond to an extended error code as described in further detail below.

FIG. 4B is a byte layout diagram 425 illustrating decoding of extended error code 430 with associated meanings for each byte segment. The extended error code 430 is shown organized from most significant bit (MSB) to least significant bit (LSB), and is structured into five segments 435a-d. Below each segment label is a meaning or description 440a-d associated with each segment. Such segments and associated meanings may be retrieved through a MIB as described below with reference to FIG. 6A.

Bits 0-4 (435a) represent a standard SNMP error code, such as the example error code and associated meaning as shown. Bits 5-7 are reserved for future extendibility incase SNMP standard introduces new error codes. Bits 8-19 (435b) represent an extended error code, which may be specific to an application or other component of a network element, such as enterprise specific debug information (ESDI). The extended error code is associated with a description that provides further meaning to the fault condition, and may be used to perform debugging at the source of the fault condition.

Bits 20-25 (435c) and 26-31 (435d) represent a sub-module Identifier and a module Identifier, respectively. These identifiers point to the source of the fault condition and an accompanying description of each identifier (440c, 440d) may be conveyed to a network administrator as a human-readable string for locating the source of the fault condition.

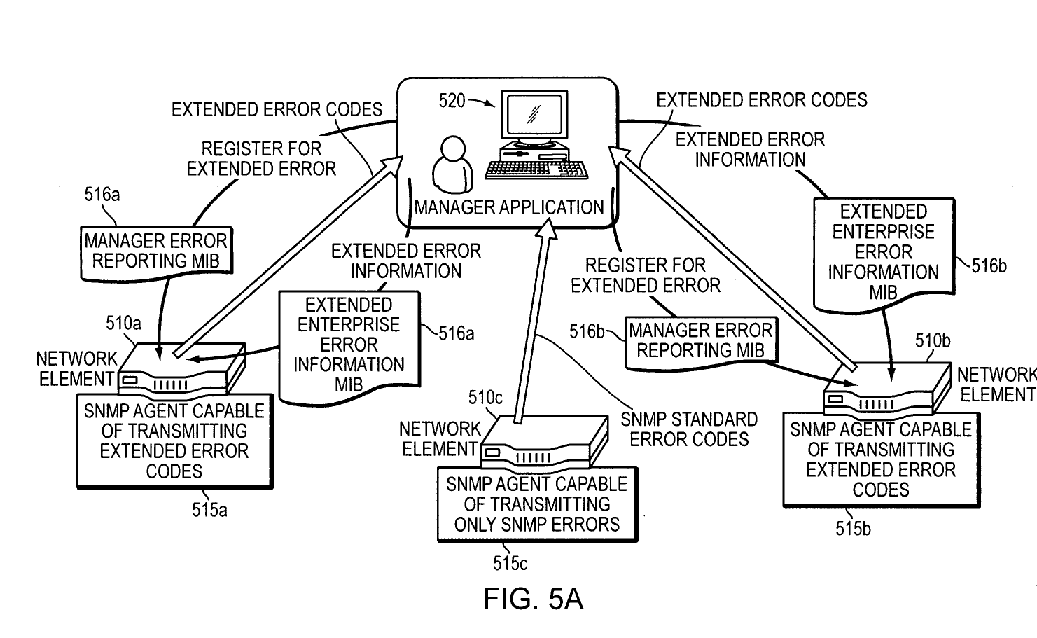

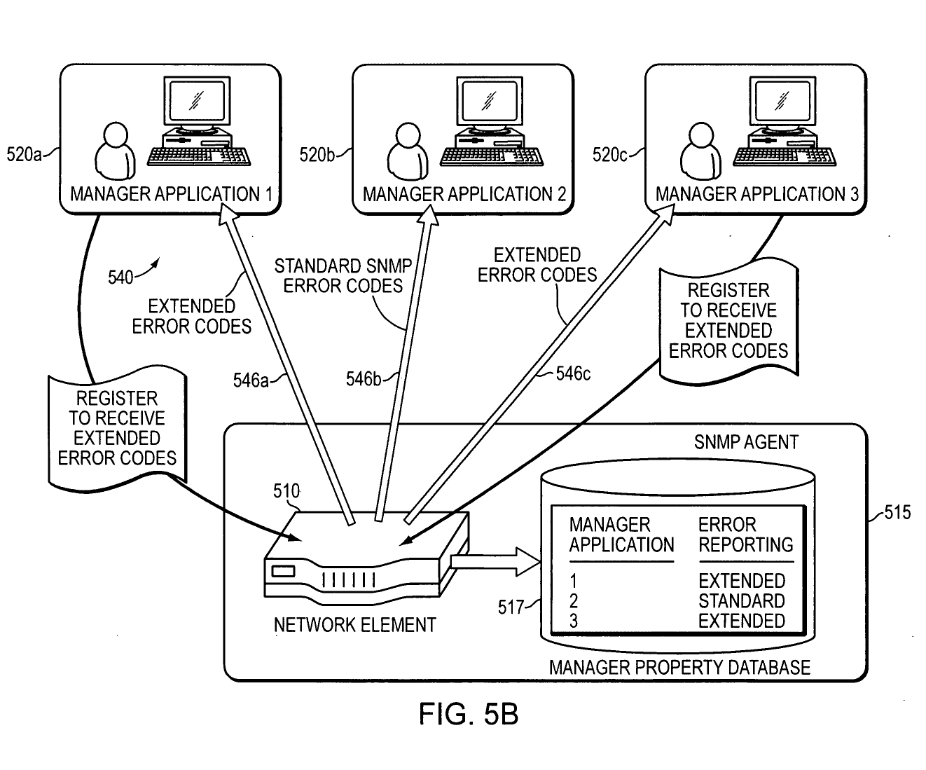

FIG. 5A is a block diagram of a network configuration featuring a Manager 520 managing multiple Network Elements (NE) 510a-c through SNMP communications across a network, with at least some of the NEs 510a-c providing extended error codes. Each network element 510a-c includes a respective SNMP agent 515a-c for communicating with the Manager 520 via associated SNMP communications. Each network element 510a-c and the Manager 520 may be comparable to the network element 110 and the Manager 120, respectively, described above with reference to FIG. 1.

Alternatively, in the example network, two agents 515a, 515b that support extended error reporting may access an associated management information base (MIB) 516a, 516b respectively, for Manager to configure management data, and retrieve information such as error code segments and associated meanings. The third agent 515c is a legacy agent capable only of providing standard error codes to the NMS.

In addition, each network element 510a, 510b includes its own MIB 516a, 516b can be configured in a proprietary manner to report debug and other information that may be distinct from reporting by other network elements 510c. For example, the two network elements 510a, 510b that can report extended error codes may be configured to report identical error codes to the Manager 520, yet the associated meanings may be distinct at each network element 510a, 510b. Because the Manager may rely on NE for error code meanings and not necessarily interpret an extended error code (but may interpret the meaning of a received standard (e.g., SNMP) error code), the Manager 520 is capable of receiving extended error codes from multiple network elements 510a-c regardless of their associated meanings.

FIG. 5B is a block diagram of a network configuration featuring multiple Managers 520a-c managing a single network element 510 via SNMP communications across a network. Each Manager 520a-c and the network element 510 may be configured comparably to the Manager 120 and the network element 110, respectively, described above with reference to FIG. 1. The network element 510 includes an agent 515 (e.g., an SNMP agent) with MIB database 517 that is responsive to management requests from each of the Managers 520a-c through associated communications 546a-c.

In some configurations, one or more of the Managers 520a-c may not be configured for receiving or reporting results of extended error codes. For example, Managers 520a, 520c may be capable of following a process as described above to transmit a first and second request to the agent 515 to receive an extended error code and its associated meaning, while a third Manager 520b is a legacy device or is otherwise unable to process extended error codes. Accordingly, the agent may selectively enable extended error reporting for the two extended error code compatible Managers 520a, 520c, and disables extended error reporting to the other Manager 520b, instead reporting a standard error code. Such selective reporting may also be determined by the characteristics of modules (not shown) within the network element 510. For example, the agent 515 may detect a fault condition at a module, but may be unable to recover operational data sufficient to locate an appropriate extended error code within the MIB. In such a case, the agent may report a standard SNMP code or may report any portions of an extended error code that can be retrieved, such as a module or sub-module identifier. Thus, the network element may select between different modes of error reporting to accommodate both the available data on a fault condition and the compatibility of a Manager receiving the error code.

FIG. 6A is a diagram 600 showing structure of Manager Error Reporting (MER) MIB usable in example embodiments of the invention. The MER data may be maintained at a network element, such as the network element 110 shown in FIG. 1, and provides information about the one or more network managers with which the network element communicates. The first object, “mgrErrorReportMode,” indicates the mode of error reporting that the network element uses while communicating an error code to the respective network manager. Such modes, as described above with reference to FIG. 5B, can include standard error reporting, where the network element provides a standard (e.g., standard SNMP) error code, and extended error reporting, where the network element provides an extended error code. Additional data in the entry defines data type (e.g., an integer of specified range), and access to read, create or modify the entry.

The second object, “mgrRowStatus,” enables the creation of a new entry in the table 600, or the deletion of an entry in the table 600. In this manner, the table 600 can be updated to maintain information on error reporting to one or more network manager(s) as those managers are added to (or removed from) an associated network.

FIG. 6B is a diagram 601 showing structure of Extended Enterprise Error Information MIB usable in example embodiments of the invention.

Entries in the leftmost column indicate a category of error code or data associated with the error code: “entStandardError” identifies a standard SNMP error code; “entErrorCode” identifies an extended error code, which is associated with additional debug information such as ESDI; “entModuleId” identifies a particular module as the source of a fault condition; “entSubModuleId” identifies a particular sub-module of a respective module as a source of a fault condition; and “entErrorString” identifies an error string (e.g., human-readable error string) that is associated with the extended error code. Additional data in the entry defines data type (e.g., a number of fixed length or a display string), and access to read, create or modify the entry.

It should be understood that the block diagrams of FIGS. 1, 2D and 5A-B, the tables of FIGS. 4B and 6A-B, the sequence diagrams of FIGS. 2A and 2C and the flow diagram of FIG. 2B are examples that can include more or fewer components, be partitioned into subunits, or be implemented in different combinations. Moreover, the flow diagrams and components of the block diagrams may be implemented in hardware, firmware, or software. If implemented in software, the software may be written in any software language suitable for use in networks and network devices as illustrated in FIG. 1. The software may be embodied on any form of computer readable medium, such as RAM, ROM, or magnetic or optical disk, and loaded and executed by generic or custom processor(s).

While this invention has been particularly shown and described with references to example embodiments thereof, it will be understood by those skilled in the art that various changes in form and details may be made therein without departing from the scope of the invention encompassed by the appended claims.

What is claimed is:

1. A method of extending error reporting from a network element to a network management system, the method comprising:
responding to a first request from a network manager to a network element with an error code that includes debug information beyond a standard error code in a response message; and
responding to a second request from the manager that includes an indication of the debug information with meanings of the debug information to provide the extended error reporting from the network element.

2. The method of claim 1 wherein the indication of the debug information is the debug information itself.

3. The method of claim 1 further comprising advertising availability of enterprise specific debug information functionality.

4. The method of claim 1 further comprising selectably enabling standard or extended error reporting.

5. The method of claim 4 wherein the enabling is applied to a single manager.

6. The method of claim 4 wherein the enabling is applied for multiple managers, standard or extended error reporting being enabled on a per-manager basis.

7. The method of claim 1 wherein the responding to a first request includes using more significant bits in an error code field carrying the error code than is used in the standard error code.

8. The method of claim 1 wherein the meanings of the debug information include at least one of: modules, sub-modules, and human readable error string.

9. The method of claim 1 wherein the meanings of the debug information include indications of hierarchy among modules or sub-modules within the network element.

10. The method of claim 1 further comprising enabling a Management Information Base that includes the meanings to be updated in a manner independent of the manager.

11. The method of claim 1 wherein the standard error code is a Simple Network Management Protocol (SNMP) error code.

12. The method of claim 11 further comprising reserving space beyond the standard set of SNMP error codes in the error code field within the response message while responding with the debug information.

13. The method of claim 1 wherein the debug information is Enterprise Specific Debug Information (ESDI).

14. The method of claim 1 wherein the debug information includes an error code identifying one or more of: modules, sub-modules, and human readable error string.

15. An apparatus for providing extended error reporting from a network element to a Network Manager, the apparatus comprising:
an agent configured to respond to a first request from a network manager with an error code that includes debug information beyond a standard error code in a response message; and
a management information base (MIB) storing an indication of the debug information with meanings of the debug information, the agent configured to provide the indication and meanings in response to a second request, which includes an indication of the debug information, from the network manager to provide extended error reporting from the network element.

16. The apparatus of claim 15 wherein the indication of the debug information is the debug information itself.

17. The apparatus of claim 15 wherein the network element advertises availability of enterprise specific debug information mechanism.

18. The apparatus of claim 15 wherein the agent is configured to selectably enable legacy or extended error reporting.

19. The apparatus of claim 18 wherein the enabling is applied to a single network manager.

20. The apparatus of claim 18 wherein the enabling is applied for multiple network managers, standard or extended error reporting being enabled on a per-network manager basis.

21. The apparatus of claim 15 wherein the agent responds to the first request by using more significant bits in a protocol data unit (PDU) error code field carrying the error code than is used in the standard error code.

22. The apparatus of claim 15 wherein the meanings of the enterprise specific debug information include at least one of: modules, sub-modules, and human readable error string.

23. The apparatus of claim 15 wherein the meanings of the enterprise specific debug information include indications of hierarchy among modules or sub-modules within the network element.

24. The apparatus of claim 15 wherein the Management Information Base includes the meanings to be updated in a manner independent of the network manager.

25. The method of claim 15 wherein the agent is a Simple Network Management Protocol (SNMP) agent.

26. The apparatus of claim 25 wherein the SNMP agent is configured to reserve space beyond the standard error codes in the error code field with the response message while responding with the debug information.

27. The apparatus of claim 15 wherein the debug information is Enterprise Specific Debug Information.

28. The apparatus of claim 15 wherein the debug information includes an error code identifying one or more of: modules, sub-modules, and human readable error string.
